(19) United States
(12) Patent Application Publication
(10) Pub. No.: US 2009/0198528 A1
(43) Pub. Date: Aug. 6, 2009

(54) System and method providing market mechanisms for trading in forward contracts on heterogeneous goods

(75) Inventor: Barry S. Kahn, Austin, TX (US)

Correspondence Address: THE JANSSON FIRM, 9501 N. CAPITAL OF TX HWY #202, AUSTIN, TX, 78759, US

(73) Assignee: Qcue LLC, Austin, TX (US)

(21) Appl. No.: 12/317,720

(22) Filed: Dec. 19, 2008

Related U.S. Application Data
(60) Provisional application No. 61/008,238, filed on Dec. 19, 2007.

(51) Int. Cl. G06Q 30/00; G06Q 10/00; G06Q 50/00

(52) U.S. Cl. 705/5; 705/26

(57) ABSTRACT

System and method for trading in forward contracts exchangeable for tickets to events. A computerized exchange of the box office provides for trading forward contracts exchangeable for tickets to events. Instructions direct a central processing unit to receive bid and ask requests for forward contracts wherein each bid and ask includes a tickets description, match bid records against ask records using a matching criteria including instructions to match multiple asks or unreleased ticket inventory to satisfy one bid by aggregating tickets descriptions from the multiple asks or unreleased ticket inventory to satisfy the tickets description in a bid record, and upon close of the virtual market in forward contracts, delivering from the issuer to a holder of forward contracts, tickets corresponding to each respective forward contract ticket description.

### CROSS-REFERENCE TO RELATED APPLICATIONS

This application is a non-provisional application claiming priority from provisional application Ser. No. 61/008,238, filed on Dec. 19, 2007, entitled “METHOD OF TRANSFERRING ITEMS FROM PRIMARY SELLER TO END CONSUMERS,” the teachings of which are incorporated by reference herein as if reproduced in full below.

### BACKGROUND OF THE INVENTION

The present invention relates generally to commerce in heterogeneous goods and more particularly to a computerized system and method for providing sale, resale, and delivery of heterogeneous goods.

Determining accurate pricing for event tickets is difficult due to unknown and fluctuating consumer demand and the risk of overpricing. Scalpers have taken advantage of this arbitrage opportunity to create a multi-billion dollar secondary market that rivals the primary market in both size and profitability. This scenario is repeated in markets for other consumer products where sellers lack the information and power necessary to set and adjust price in response to consumer demand.

This difficulty in event ticket pricing causes three main problems. First, there is an allocation problem in that sellers find it difficult to efficiently allocate high-demand products amongst customers; there are limited signaling mechanisms which allow the seller to distinguish which customers value the product most. Secondly, there is a customer service problem resulting from customers being forced to wait in lines, contest with busy phone lines and internet servers, subject themselves to lotteries, incur costly and inconvenient resale, and face other inconveniences. Finally, there is the financial problem in which the primary seller is currently forced to choose between a high price, thereby risking low sales, and a low price, thus losing the potential financial gains from high price and quantity.

This financial problem is particularly acute for the live music industry, especially for concert promoters. Approximately fifty-five percent of all concert tickets released go unsold annually. Simultaneously, ten percent of all tickets are resold at an average of 2× face value. For sporting events, season tickets (representing 70% of all tickets) mitigate the risk or poor attendance, but the size of the market is 3× larger (gross ticket sales of $11.7 billion), price fluctuations are more severe due to variables like team and opponent performance, and there is an inherent rate of resale amongst season ticket holders, resulting in a $1.2 billion secondary market and the need for dynamic pricing capabilities.

This pricing problem is not isolated to the ticketing industry. Similar opportunities exist for new release retail products that sell for multiples of MSRP on eBay and other online auctions sites. Examples of such products include gaming consoles, high tech devices, video/computer games, and assorted other “hot” new release items during the holiday season. Other products that do not see this same secondary market presence, but have time-fluctuating pricing and an expiration date; for example, airline tickets, hotel rooms, and timeshare reservations often have variable pricing in the primary market. However, these products are sold in a manner where returns are costly, pricing is not transparent, and demand is not directly observable.

Problems of similar nature for commodities such as oil, agriculture, and minerals have been solved with futures markets. Yet, no such approach has ever been taken for consumer products largely because, unlike in the oil, agriculture and mineral markets, the necessity for the commodity is not a means to hedge risk, but an efficient means of allocation and delivery. Therefore a forward contracts market is the more appropriate solution; a marketplace that enables contracts on the future delivery of consumer products would enable competitive pricing and allocation in an integrated market for which primary and secondary sellers can participate. A forward contracts market for consumer products has not been attempted because consumer products, and tickets in particular, are not homogenous; and in the cases they are, the manner they are sold in the primary market creates a heterogeneity that has previously made a forward contracts market impossible. However, by integrating the primary and secondary markets, it is possible to create an environment in which the buyers, sellers, and items lose their separate identities and become part of a consolidated net settlement process.

Online marketplaces, such as eBay, Inc., San Jose, Calif., and Craigslist, Inc., San Francisco, Calif., have created value out of these mispriced consumer products, allowing resellers to capture the difference between retail price and market value, and market places such as StubHub, San Francisco, Calif., owned by eBay, Inc., San Jose, Calif., and TicketsNow, Rockford, Ill., owned by Ticketmaster, West Hollywood, Calif., have offered primary sellers a percentage (or fixed fee) of the resale for tickets to their event. However, these markets are subject to complementarities, which reduce the size of the secondary market because the presence of ex-ante identical but simultaneous auctions prevent buyers from bidding on all items and prevent sellers from receiving bids from all potential buyers.

Additionally, attempts have been made through legislation, technology, and incentives to stop secondary markets, but such solutions do not bring additional revenue to primary sellers. Neither solution addresses the root of the problem: mispricing in the primary market and the natural fluctuations in value over time.

Happel and Jennings (2002) discuss the abundant advantages of a futures market for tickets, but list seat grouping, lack of homogeneity, and low liquidity as reasons that make such a market infeasible. As a result, this dual problem stemming from pricing issues has been ignored and instead the focus of innovation has been on increasing the efficiency and liquidity of secondary markets.

Increasing the efficiency of secondary markets was the goal of U.S. Pat. Nos. 6,067,532 by Gebb (2000), 6,107,932 by Walker et al. (2000), 6,308,159 by Strohl (2001), 6,704,713 by Brett (2004), 6,847,939 by Shemesh (2005), 7,003,485 by Young (2006), 7,080,050 by Himmelstein (2006). Websites such as StubHub, eBay, and viagogo, London, UK, have used these and similar inventions to create value by matching resellers and buyers. Online marketplaces were able to change the dynamic of the pre-internet secondary market, in which professional ticket brokers and scalpers served as middlemen, buying and selling tickets from individuals. But such markets exclude the primary sellers, who are unable to capture value from participating in these markets. These markets merely represent missed opportunity to the primary seller who is constrained by face value. Additionally, the presence of these markets actually decreases advance ticket sales as the ease of purchasing on secondary markets reduces fear of sellouts, the primary factor in motivating advance ticket sales.

Attempts have been made to allow the primary seller to maintain some control over the secondary market. Methods of using authentication data as opposed to paper tickets, such as U.S. Pat. No. 6,496,809 by Nakfoor (2002) and US Patent Application 20,040,006,497 by Nestor et al. (2004) have the potential to control unauthorized resale on secondary markets. Flash Seats, the secondary market for Veritix, Inc. located Cleveland, Ohio, has implemented a similar technology. However, such methods require potentially costly equipment at venues. They also do not maintain the anonymity of the seller since seats are assigned on the primary sale. Thus the primary seller can be differentiated from secondary sellers, limiting participation by the primary seller and causing customer relations problems and potentially differentiating the value of tickets based upon knowledge of the seller. Seller ratings on online auction sites are an example of this phenomenon occurring in similar environments.

TicketExchange, a secondary market operated by Ticketmaster, West Hollywood, Calif., uses a means of invalidating tickets and creating new ones as described in U.S. Pat. No. 6,240,396 by Walker et al. (2001). This facilitates transactions on the secondary market by making interaction no longer necessary between buyers and sellers. Yet, buyers and resellers are still free to conduct transactions in other marketplaces and the primary seller sees no benefits from this improved efficiency. Additionally, resellers have no guarantee of being able to sell a ticket, regardless of pricing; once tickets have been differentiated—by seat, owner, etc. a buyer must choose a specific ticket, not merely the lowest price. This results in a degree of randomness that is not beneficial to buyers or sellers.

fristDIBZ, Inc (formerly TicketRESERVE) located Chicago, Ill., and yoonew, Inc. located New York, N.Y., have implemented a futures exchange-like marketplace, based upon U.S. Pat. No. 7,206,755 by Muralidhar (2007). Such a marketplace creates financial instruments from tickets with variable outcomes; arbitraging the difference between the value of a certain commodity (a ticket to a championship sporting event) and a set of options that is identical to the certain commodity (options for every team with the opportunity to compete). This marketplace provides a means of hedging risk, for buyer and sellers, but is not a means of releasing items in the absence of uncertainty. The dual goals of controlling the secondary market and more accurately setting and adjusting price in the primary market are not addressed; it does not provide a dynamic price adjustment solution for primary sellers once the outcome is certain and is therefore not a means of allocation and distribution for an entire supply. While using an exchange mechanism similar to the present invention, as do stock and futures markets, the application of the mechanism is distinctly different. Creating a futures options market for event tickets does not integrate the primary and secondary markets, instead providing a decisively different means of allocating items to end consumers that is not applicable when uncertainty does not lend itself to the creation of options capable of being arbitraged.

Accordingly, there remains a need for a solution for the primary seller that allows for a means of dynamic pricing by the primary seller in conjunction with resellers. Such a solution should provide arrival at the correct price, adjustment of price in the face of changing market conditions; and control of the secondary market to capture value from inevitable resale. This would allow a primary seller to simultaneously address his two largest concerns: mitigating the risk of poor attendance and profiting from resale.

From the foregoing it is apparent that there is still a need for an improved system and method that merges the primary and the secondary market for event tickets, as well as for other markets in heterogeneous goods, through an exchange in which items lose their separate identities thereby becoming exchange tradable.

### BRIEF DESCRIPTION OF THE DRAWINGS

FIG. 1 is a block diagram illustrating message flow between a primary seller, an exchange for forward contracts on heterogeneous items, a ticket reseller and an end consumer.

FIG. 2 is a block diagram illustrating Phase I of the operation of the exchange.

FIG. 3 is a block diagram illustrating Phase II of the operation of the exchange.

FIG. 4 is a block diagram illustrating Phase III of the operation of the exchange.

FIG. 5 is a schematic illustration of a computer network in which an exchange for trading items in a heterogeneous market is located.

FIG. 6 is a schematic illustration of an alternative embodiment for trading securities in event tickets.

FIG. 7 a hardware block diagram illustrating the hardware component of an exchange server computer

FIG. 8 is a block diagram illustrating some of the application programs, systems programs and data files stored in the storage device of FIG. 7.

FIG. 9 is a database schema for the TSE database.

FIG. 10 is a seating chart for an arena.

FIG. 11 is a timing sequence diagram illustrating the message flow between a promoter and the exchange.

FIG. 12 is a representation of a user interface for creating an event.

FIG. 13 is a timing sequence diagram illustrating the offering of securities on the exchange.

FIG. 14 is representation of a web page dashboard for a user.

FIG. 15 is representation of a user interface page illustrating the user interface that is presented to a seller.

FIG. 16 is a timing sequence diagram illustrating the bidding for securities on the exchange.

FIGS. 17a and b are representations of web pages for buying tickets.

FIG. 18 is a flow chart illustrating the operations of the matching mechanism of the exchange to affect the best possible price for a buyer.

### DETAILED DESCRIPTION OF THE INVENTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

In an embodiment of the invention, a box office for the sale of tickets to events such as music concerts and sporting events is transformed to allow for the orderly sale and exchange of tickets beginning with an initial ticket release by the primary seller, e.g., a promoter of the event. As will be discussed in greater detail below, the exchange allows persons who have purchased a ticket, or more precisely who have purchased a forward contract exchangeable for delivery of a ticket, to resell that forward contract through a market mechanism by which a market price for the ticket may be established. The primary seller, i.e., the issuer of the tickets such as the box office or the promoter, may participate in a market that integrates the primary and the secondary markets as a purchaser or seller of tickets to purchasers who have expressed an interest in purchasing tickets on the secondary market. Hereinafter, the market that integrates the primary and the secondary markets is referred to as the integrated market. In one embodiment, authenticity, traditionally a significant issue on the secondary market, is enhanced by placing responsibility for ticket delivery for tickets sold via this secondary market on the primary seller, e.g., the issuer, promoter, or box office. In other words, even if a ticket has been sold by a secondary seller, for example a scalper, to an end customer who intends to attend the event rather than resell the ticket, the ticket is delivered from the primary seller to the end customer. By having the ticket ultimately delivered from the primary seller, the customer may have much greater confidence in the authenticity of the ticket than the customer would have had if the ticket had been purchased from a reseller using traditional mechanisms.

The method and system for transforming a box office as described herein further enhances the market in ticket sales by providing a mechanism in which the primary seller may participate in the integrated market to more accurately price tickets in response to market demand. As sales in tickets to an event transpire, through an exchange as described herein, the primary seller may observe the customer demand, the behavior of resellers, and the market price established through the exchange mechanism and release additional inventory at the market price or at a price that in some manner reflects the market price and/or customer demand. Thus, a primary issuer of tickets to an event avoids, or at least mitigates, the risk of over-pricing or under-pricing a large inventory of tickets.

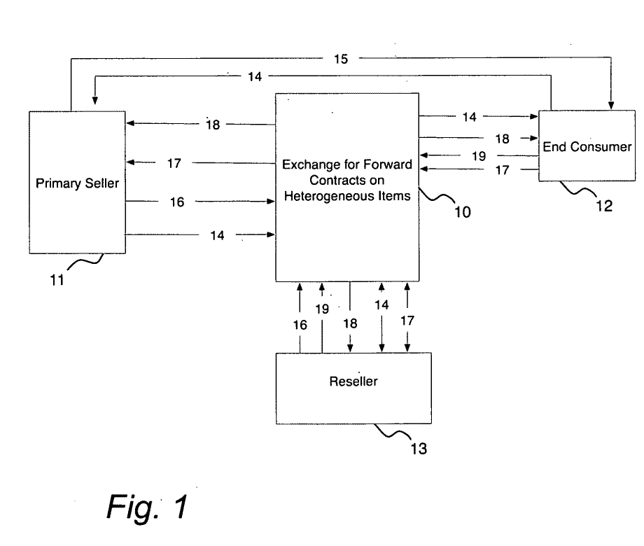

FIG. 1 is a block diagram illustrating message flow between a primary seller 11, an exchange for forward contracts on heterogeneous items (hereinafter, “the exchange”) 10, a ticket reseller 13 and an end consumer 12. In this illustration the exchange 10 facilitates transactions between the primary seller 11, a plurality of end consumers 12, and a plurality of resellers 13. The primary seller 11 submits forward contracts guaranteed to be exchangeable for delivery of a ticket(s) at a predetermined delivery date 14 (hereinafter referred to as “forward contracts” 14) for a plurality of items 15. The primary seller also submits asks 16, consisting of an ask price and ask quantity (non-competitive asks) or an ask quantity and an agreement to sell at the best-offered price to buy (competitive asks), and receives payment 17 and information 18 relevant to determining pricing strategies.

The end consumers 12 submit bids 19, consisting of a bid price and bid quantity, and payments 17 and receive the guarantees 14 and information 18 relevant to determining market value.

The resellers 13 submit bids 19, asks 16, payment 17, and forward contracts 14 of future delivery of items 15 into the marketplace and receive information 18, forward contracts 14, and payments 17. The resellers 13 never possess the item (e.g., a ticket) 15, and if the reseller 13 successfully sells all the forward contracts that the reseller 13 purchases, the reseller 13 has zero net receipt of guarantees 19 and a potentially nonzero net receipt of payments 17.

A given entity may function both as a reseller 13 and as an end consumer 12. At a predetermined date, after the market in forward contracts has closed, the primary seller 11 delivers the items to the end consumers 12 in fulfillment of the obligation of the guarantees of delivery associated with the forward contracts 14. With the possible exception of this final delivery, the primary seller 11, the end consumers 12, and the resellers 13, interact only anonymously through the Exchange 10, with potentially full novation.

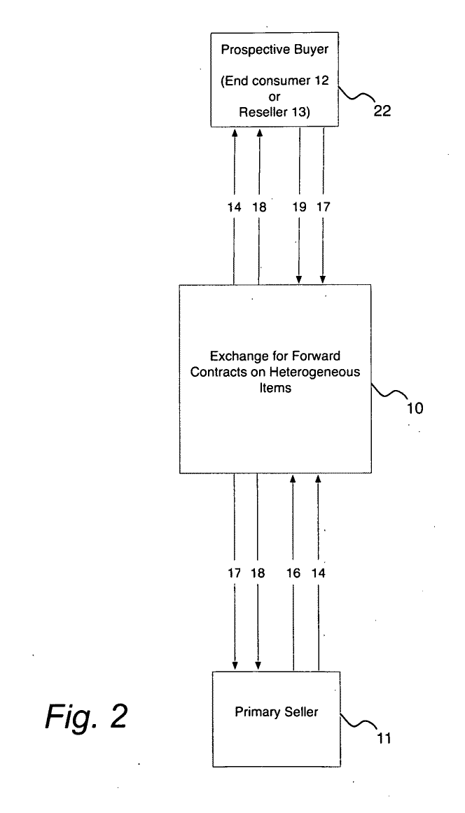

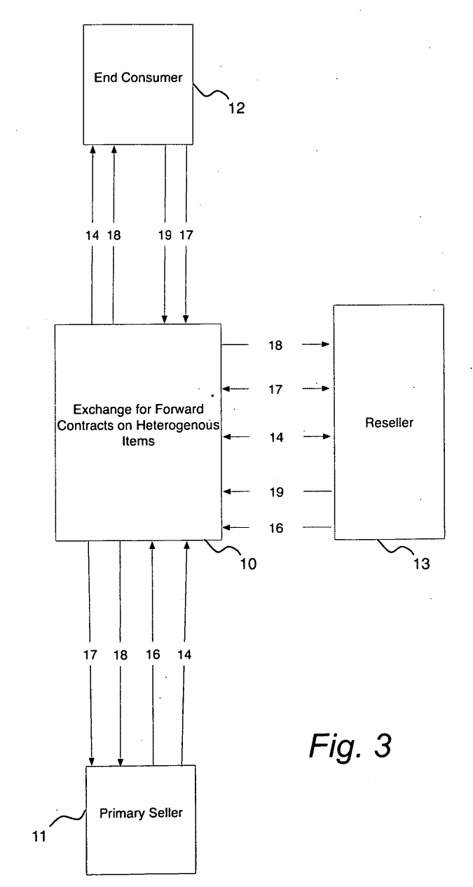

FIGS. 2, 3, and 4 are block diagrams illustrating the operation of the exchange 10 from a high-level perspective in three phases. Phase I consists of the submission of guarantees, asks, and bids on the exchange. Phase II consists of the trading of guarantees during an active market in the guarantees. Phase III occurs after the market has closed, trading has ceased, and delivery of the underlying items has been made.

FIG. 2 illustrates Phase I. In Phase I, the primary seller 11 submits forward contracts 14, and the respective asks 16. The asks 16 received from the primary seller 11 and bids 19 received from prospective buyers 22, potentially an end consumer 12 or a reseller 13, are listed on the exchange 10. The primary sellers 11 can adjust asks 16, in response to the bids 19, and prospective buyers 22 can adjust their bids 19 in response to the bids 19 of other buyers 22 and the asks 16 of the primary seller 11.

In the event that a bid 19 and ask 16 are matched, the forward contract 14 is transferred to the buyer 22, and payment is transferred to the primary seller 11 and the items 15 return to primary seller 11 and are used to fulfill the forward contract 14 obligation to deliver at the predetermined date after the close of the market.

In Phase II, illustrated in FIG. 3, a non-negative quantity of forward contracts 14, are held by buyers 22, either end consumers 12 or resellers 13, due to previously matched bids 19 and asks 16, and the remainder are held by the primary seller 11. The buyers 22 differentiate into end consumers 12 and resellers 13; any entity can take on any role, i.e., a buyer 22 who has obtained forward contracts may either take delivery of the tickets associated therewith, or resell the forward contracts. At the time of purchase of a forward contract the ultimate role of the buyer is not defined. In the event that a buyer 22 becomes a reseller 13, the buyer 22, as a reseller 13, submits asks 16 for a non-negative quantity of forward contracts 14, that the buyer 22 holds. These asks 16 are seen by other prospective buyers 22 and matched with bids 19 as if the asks 16 were submitted by the primary seller 11.

A reseller 13 and the primary seller 11 are indistinguishable to potential buyers 22. In the case that such an ask 16 is matched, payment 17 which is equivalent to the match price is received by the reseller 13, minus a non-negative amount allocated to the primary seller 11 and/or a third party facilitator, e.g., the operator of the exchange 10.

The primary seller 11 may submit additional forward contracts 14 into the marketplace as in Phase I. Matched asks 16 submitted by the primary seller 11 are treated as in Phase I.

Phase II, with a potential plurality of buyers and sellers, perpetuates until the predetermined end of trading.

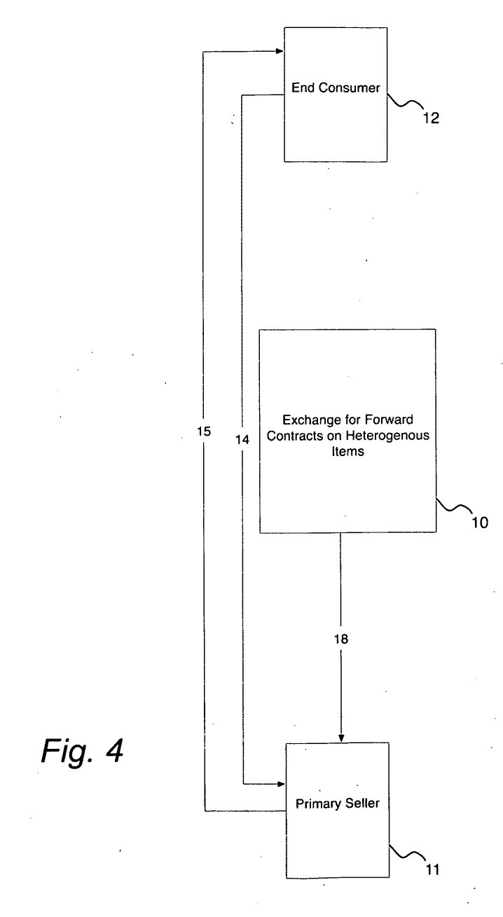

In Phase III, illustrated in FIG. 4, trading has ceased at the close of the market in forward contracts 14, and resellers 13 no longer exist as market participants having received a potentially non-zero net payment 17. The primary seller 11 receives information 18, from the exchange 10, as to the final holders of the forward contracts 14 and fulfills the obligation for the forward contracts 14 by delivering the items 15 corresponding to the forward contracts 14 to the end consumers 12.

Upon delivery, the primary seller 11 has fulfilled the contractual obligation of the forward contracts 14, and, having previously received payment 17 in Phases I and II, is no longer bound to any other market participants. The reseller 13 exited after Phase II upon receiving a potentially non-zero net payment 17 for a zero net purchase of forward contracts 14. The end consumers 12, having previously paid for forward contracts 14, receive the items 15 and are longer bound to any other market participants.

FIGS. 1 through 4 illustrate one embodiment of an exchange mechanism for trading in forward contracts in a market for heterogeneous goods. In alternative embodiments, the buyer may supply bids prior to the primary seller supplying asks, a third party may hold and deliver the items, there may be a non-contractual arrangement for ensuring delivery of the items in exchange for forward contracts, there may be a plurality of primary sellers, there may not be a plurality of items, the primary seller may also function as a buyer, and there may not be anonymity of sellers.

While the above description referring to FIGS. 1 through 4 describes a system for using an exchange to trade in heterogeneous goods generally, to illustrate the operation of the system in greater detail one such market in heterogeneous goods is described herein below, namely the market for tickets to events such as music concerts and sporting events. This description must not be taken in a limiting sense but considered as an example applicable to markets in other types of heterogeneous goods.

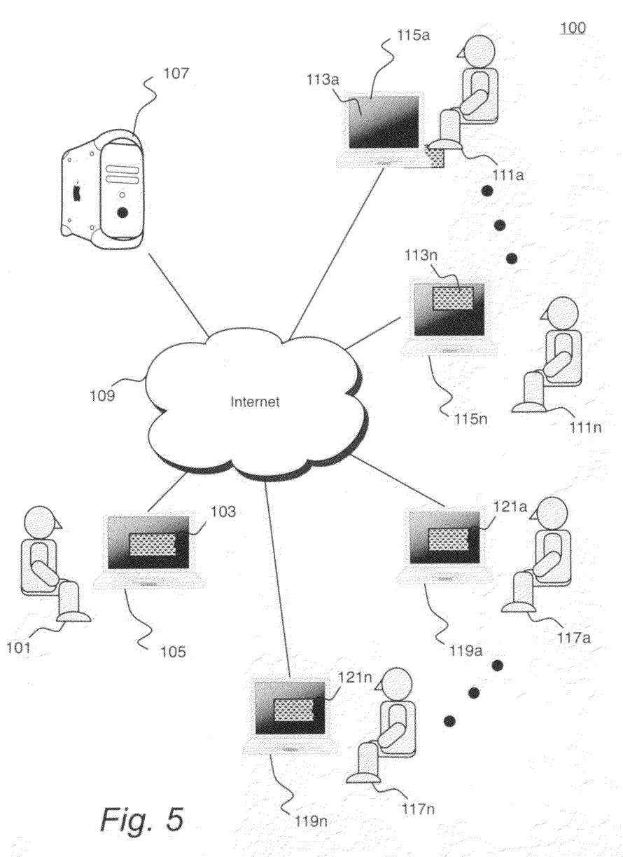

FIG. 5 is a schematic illustration of a computer network 100 in which an exchange for trading heterogeneous items, for example, event tickets, is located. To be more accurate, the trading that occurs on the exchange is in guarantees of delivery of a ticket, in a sense forward contracts exchangeable for delivery of an event ticket, i.e., a purchaser purchases, and conversely a seller sells, a forward contract that is exchangeable for delivery of a ticket from the original issuer, a promoter, or a box office that has the authorization to issue tickets from the original issuer or promoter. Hereinafter, we use the term issuer as a collective term that includes primary issuer, promoter, and any similar institution related to the original promotion of an event.

A forward contract traded in the integrated market on an exchange as described herein is defined by the following items:

Trading Unit
1 Ticket

Price Quotation
U.S. dollars and cents per ticket

Minimum Price Fluctuation
$0.01 (1¢) per ticket

Last Trading Day
Trading terminates at a date set by the promoter when defining the security.

Delivery
Via provided options, e.g., electronic delivery, various established mail delivery systems, or will-call.

Delivery Period
Between close of trading and event start time.

Seat Assignment
Ticket seat assignment will be in stated section corresponding to ticket class.

Preference for contiguous seat assignment, i.e. seats that are not separated laterally or by any rows. Contiguity may be requested across contracts from different buyers.

Payment
All payments must be made at time of purchase and for limit bids payment must be secured through a valid payment system, e.g., a credit card validation, to facilitate transfer of funds to complete transaction if bid is successfully matched. All payments made to event promoter.

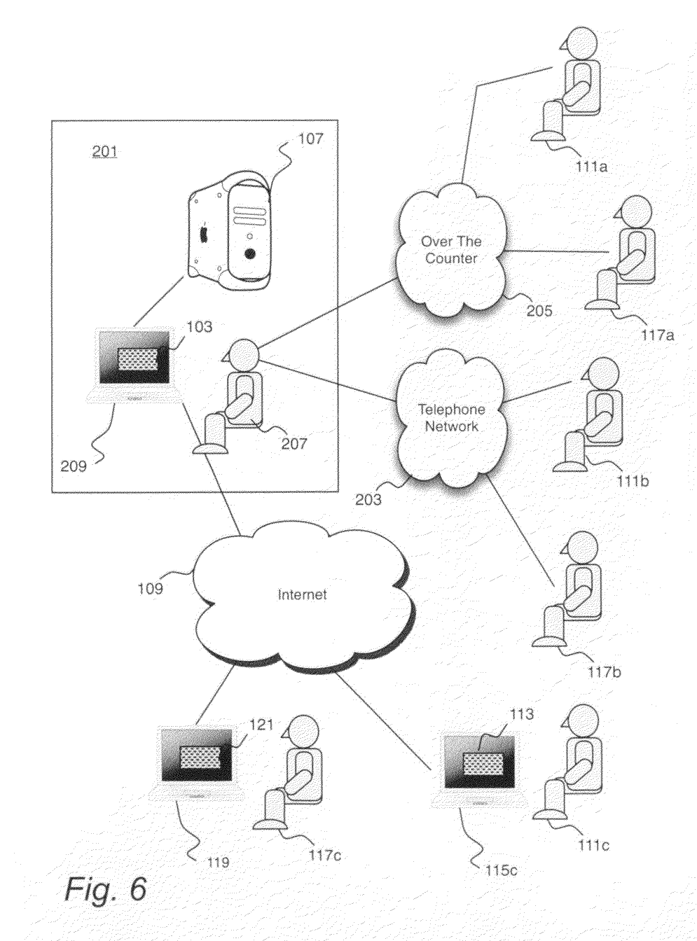

In the embodiment of FIG. 5, the issuer 101 creates events, and securities related to the event (securities related to events is discussed in greater detail below) using a web browser 103 running on the issuer's computer 105 interacting with a web server application implementing a securities exchange for trading in securities in event tickets, namely, forward contracts exchangeable for tickets on some predetermined date, as described herein (hereinafter, ticket securities exchange (TSE) or simply the exchange) and executing on an event securities exchange server computer 107 over a network 109, e.g., the Internet. Once a security has been created, end consumers 111 and resellers 117 may purchase the securities by interacting with the exchange 409 from browser 113 executing on the customers' computers 115 or from the browser 121 executing on the resellers' computers 119. It should be noted that depending on the transaction type, a user of the system can be either an end consumer 111 or a reseller 117, and from the perspective of the exchange, any user can take either role. In the illustration of FIG. 5, as well as FIG. 6, users are distinguished as end consumers 111 and resellers 117 to illustrate that the exchange interacts with users who are end consumers as well as those that are purchasing forward contracts for resale.

FIG. 6 is a schematic illustration of an alternative embodiment for trading securities in event tickets. In the embodiment of FIG. 6, the exchange 409 acts as a box office backend program. End consumers 111 interact with a box office 201 either over the network 109 using a browser 113, via telephone calls over a telephone network 203, or even over the counter 205 at a box office physical location. In the latter two alternatives, the interaction may be via an operator or clerk 207 or via an automated attendant system.

A computer system 209 of the box office 201 operates a web application (not shown) that interacts with the exchange 409 executing on the exchange server computer 107.

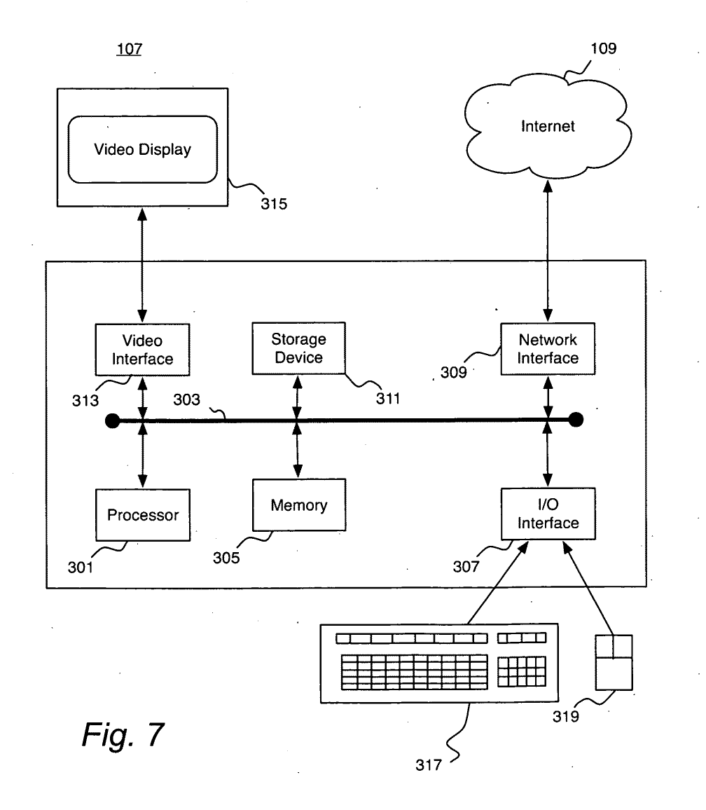

FIG. 7 is a hardware block diagram illustrating the hardware component of an exemplar exchange server computer 107. The exchange server computer 107 may consist of a central processing unit 301 connected via a bus 303 to a memory 305, an Input/Output (I/O) interface 307, a network interface 309 for connecting to the network 109, a storage device 311 for storing programs and data structures, e.g., data files and data bases, and a video interface 313 connecting to a video display 315. The I/O interface 307 is connected to a keyboard 317 and a mouse 319 to allow a user, e.g., an administrator of the exchange 409, to interact with the exchange server computer 107. It will be appreciated that where this example refers to a central processing unit, a memory, a storage device, etc., in actual implementations of the systems and methods described herein, the functionality of these devices may advantageously be spread out over multiple devices, e.g., multiple processors, multiple memories, multiple storage devices, etc., respectively. Similarly, the functionality described herein may advantageously be distributed over multiple exchange server computers 107.

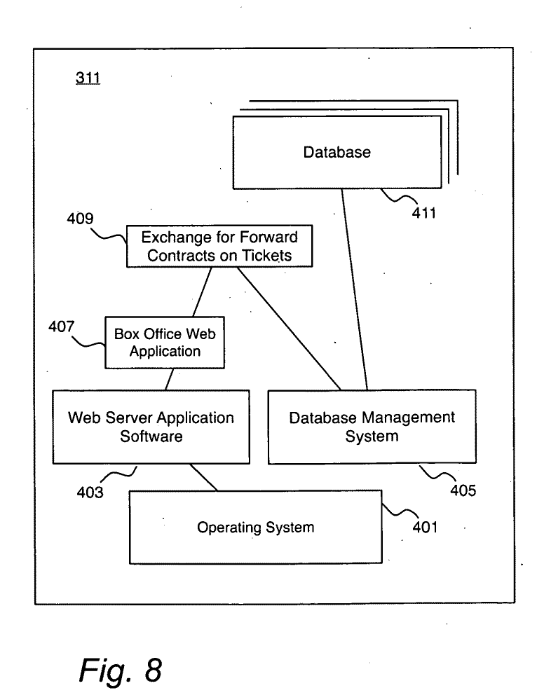

FIG. 8 is a block diagram illustrating some of the application programs, systems programs and data files stored in the storage device 311. The computer 107 is controlled by an operating system 401. Numerous other system programs may be stored on the storage device 311 including a web server program 403, e.g., the Apache HTTP server from the Apache Software Foundation, and a database management system (DBMS) 405, e.g., MYSQL Server from MySQL AB, Uppsala, Sweden.

The storage device 311 further stores application programs, including a box office web application 407. While described herein as a web application, the box office system may be a stand-alone system or a distributed system in which components communicate over a non-web protocol. However, for purposes of illustration, herein the box office system is described as a web application. The box office application 407 communicates with the exchange 409 which, in one embodiment, acts as a backend to the box office application 407 and provides the functionality allowing for market trading in event ticket securities guaranteeing delivery of tickets to events as described herein.

The exchange 409 manages data concerning ticket securities, e.g., event descriptions, order books, holders of rights in securities, etc., in one or more databases 411, described in greater detail herein below, is a database schema for the TSE databases. The TSE 409 uses the Database Management System (DBMS) 405 to access the databases 411.

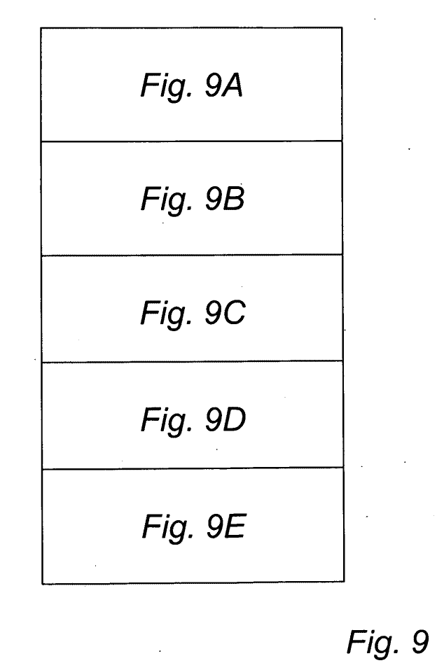

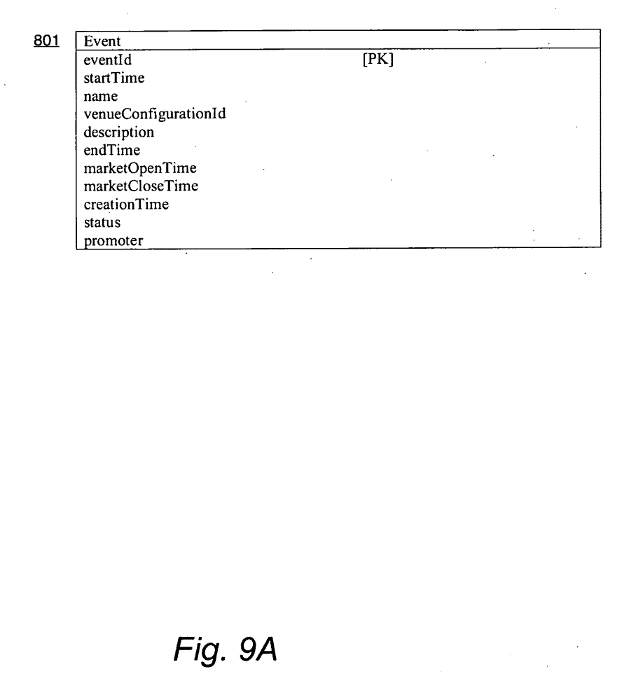

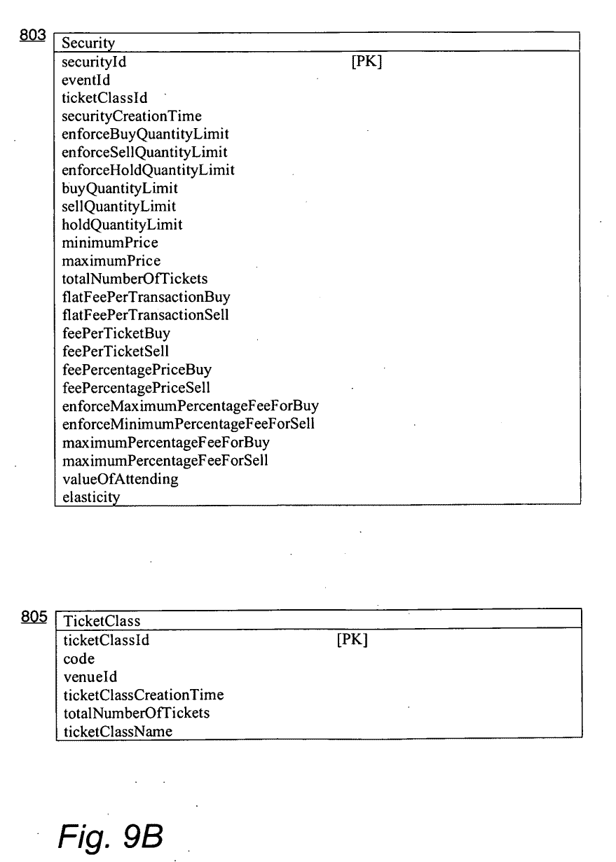

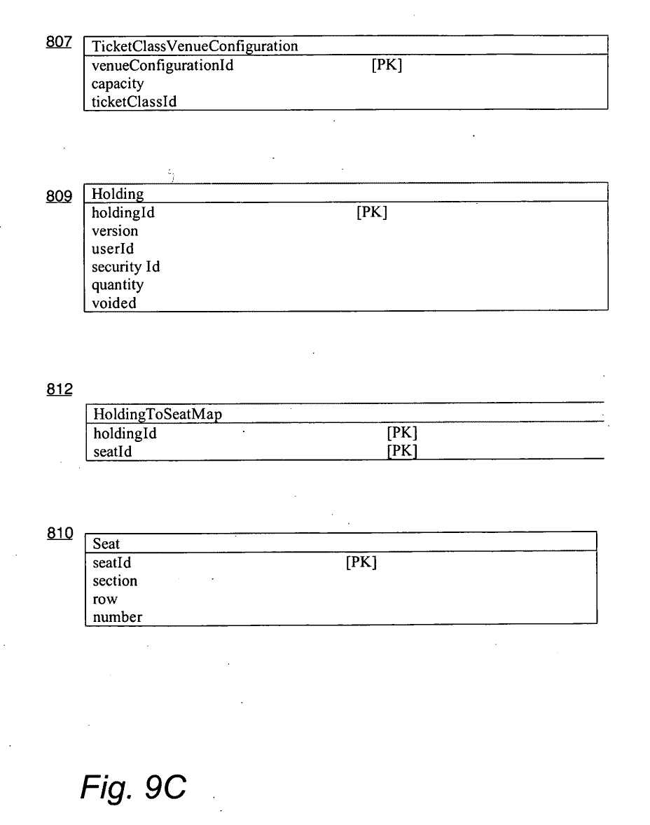

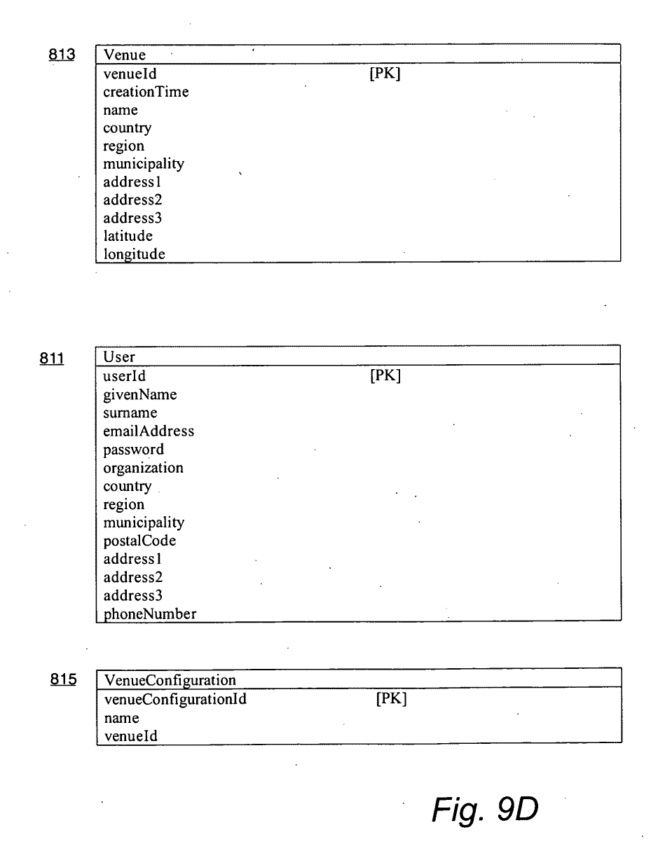

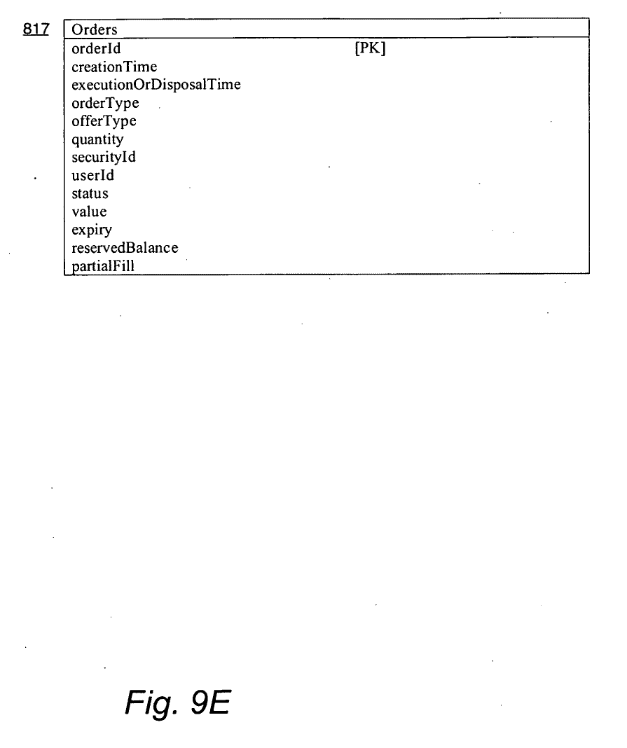

The operation of the exchange 409 is best understood in the context of the structure of the database 411. FIG. 9 is a database schema for the exchange database 411.

The exchange 409 allows for issuance of securities by a primary seller that may be traded among a user community. The securities are forward contracts that guarantee delivery of an underlying item by the primary seller at some time certain. In the example described herein the securities are forward contracts that are guaranteed to be exchangeable for delivery of tickets in particular sections of a venue for a particular event. Thus, a principal database table is the Events database table 801 as shown in FIG. 9A. The Event database table is keyed by an event ID (eventId) and contains descriptive information about an event:
name: the name of the event (name)
venueConfiguration: the venue configuration (a venue may be configured in may different ways, e.g., seating for a concert may be very different from the seating for a basketball game). Indirectly, this also defines the venue where the event occurs
marketOpenTime, marketCloseTime: when the market in trading for forward contracts to the event is to open, when the market in trading for forward contracts to the event is to close
promoter: an id pointing to the promoter (e.g., the primary seller of tickets to the event

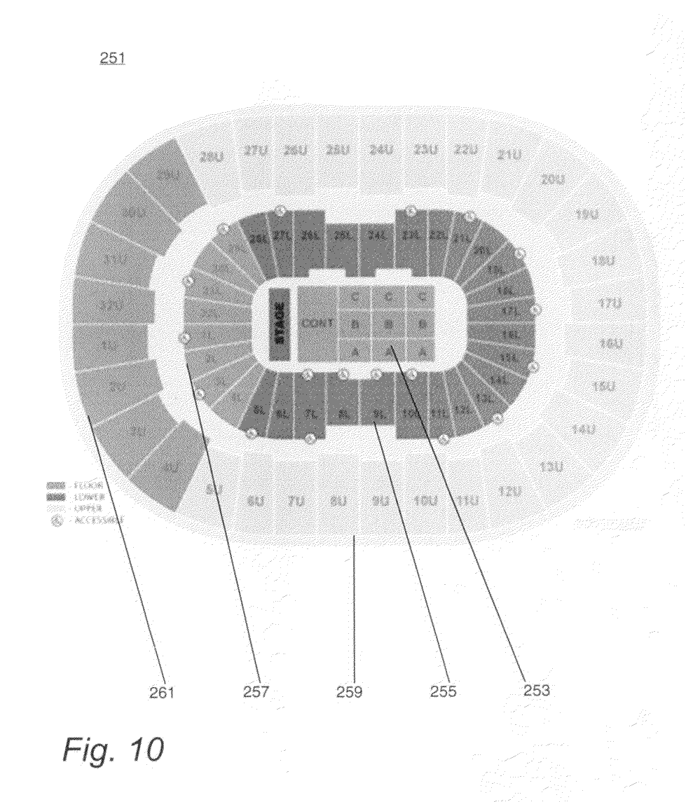

The securities correspond to particular seating classes in the given venue configuration. Each seating class corresponds to a security that may be traded using the exchange 409. Consider, for example, the seating arrangement illustrated in FIG. 10, which is a seating chart for an arena. Tickets may be issued in five classes: Floor tickets 253, Lower Level Front/Side of Stage 255, Lower Level Behind Stage 257, Upper Level Front/Side of Stage 259, and Upper Level Behind Stage 261.

As seen in FIG. 9B, the Security table 803 provides storage of information for the securities that are to be traded on the exchange 409. It is keyed by a securityId field containing a unique identifier for the security. The Security table 803 contains the following fields:
eventId: the identifier of the event to which the security corresponds
ticketClassId: the ticket class of the security, e.g., the seating class to which the security corresponds in a given venue configuration (defined by the TicketClass table 805).

The eventId and ticketClassId define that the forward contract represented by the particular security entry defined by one unique securityId guarantees delivery of a ticket permitting admission to the event defined by the eventId and seating in the ticket class defined by the ticketClassId.

The Security table 803 may contain many other fields including those illustrated in Security table 803, for example, quantity limits on buy and sell orders, minimum and maximum prices, transaction fees, etc. As discussed herein below, in one embodiment, the promoter 101 may use information gleaned from the integrated market to price later releases of ticket inventory in the form of additional issuance of forward contracts. The method for using that information may use additional information stored in the security record including valueOfAttending and elasticity. valueOfAttending represents non-ticket revenue associated with a person attending an event, e.g., parking fees, concession sales, merchandise. elasticity is a value representing a potential buyer's sensitivity to price and may be quantified as the negative of the percentage change in probability of a person buying a ticket divided by the price of the ticket. These values are entered either as default values or by the promoter 101.

The TicketClass table 805, which is keyed by a unique identifier, ticketClassId, together with the closely related table TicketClassVenueConfiguration table 807 of FIG. 9C, links a security to a particular seating section in a given venue (venueId) and venue configuration (venueConfigurationId). The venue and venue configuration are defined in Venue and VenueConfiguration tables 813 and 815 of FIG. 9D.

The beneficiary ownership of the forward contracts, i.e., the owner of the guarantee of delivery of a ticket at the end of the market, is stored in a Holding table 809. The Holding table 809 is keyed by a unique identifier, holdingId, and contains a reference to a particular user, userId, who owns a particular security, securityId, and the quantity of that security held by the user.

As discussed in greater detail herein below, in one alternative embodiment seat assignments are made at the time of delivery of actual tickets. In that embodiment, the Holding table 809 does not need to track particular seats associated with a holding of a forward contract. In an alternative embodiment, seats are assigned at the time of issuance of forward contracts from a promoter 101. In that alternative embodiment, the Holding table 809 provides either storage of that information or a link to that information held in another table.

In one embodiment, actual tickets are delivered upon the issuance of a forward contract. Because the ownership, i.e., the holding, of a forward contract may change, those tickets must be voided when ownership of a forward contract is transferred. To allow later validation of a forward contract the voided field is used. In other words, if a particular holding has changed ownership, a new entry is made in the Holding table 809 and the predecessor entry is voided by changing the value of that field.

As discussed herein above, the Holding table 809 contains a userId field for identifying the user that owns a particular holding. The users of the exchange 409 are identified in the User table 811. The User table 811 contains information concerning the user such as name and address.

The Seat table 810 links a particular identifier (seatId) to a physical seat in a venue configuration, e.g., section, row, and number. The HoldingToSeatMap mapping table 812, for each entry therein, maps a holding, defined by the holdingId to the seats associated with that holding defined by seatId.

Holders of securities may sell them on the exchange 409 through a market mechanism based on asks, bids, market orders, and matching of sell orders to buy orders. Such orders are placed in an order book in the Orders table 817 as seen on FIG. 9E. The Orders table 817 contains for each order the orderType, i.e., whether it is a Bid or Ask, and whether it is for the current market price or for a specific price, offerType. The Order table 817 also contains the security that the order is for, identified by securityId, the user who is making the order, userId, the quantity (quantity) and the value (value) offered for the security. The records of the Orders table 817 also contain information such as whether the order may be filled as a partial order and order expiration date.

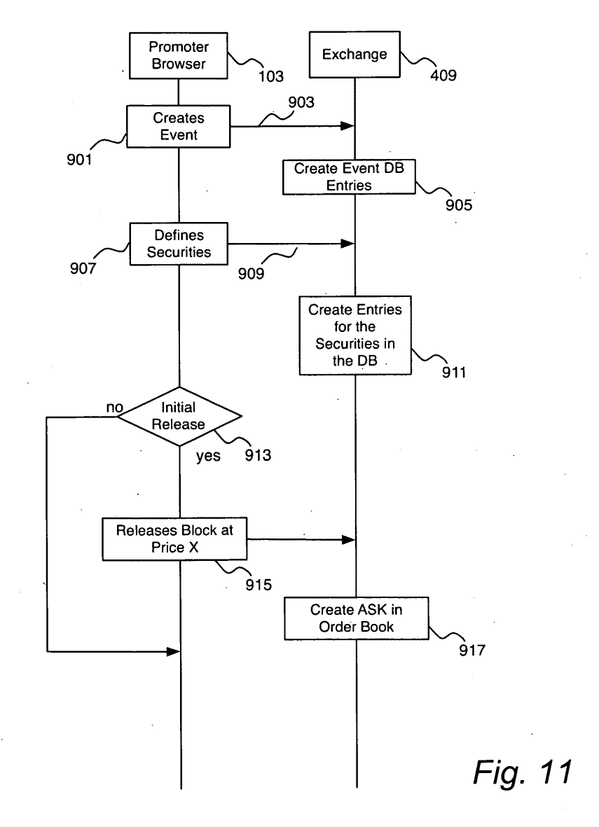

Turning now to the operation of the exchange 409. FIG. 11 is a timing sequence diagram illustrating the message flow between a promoter 101, using promoter browser 103, and the exchange 409. A promoter 101 creates an event by logging into the exchange 409 and filling in a create event user interface page, step 901.

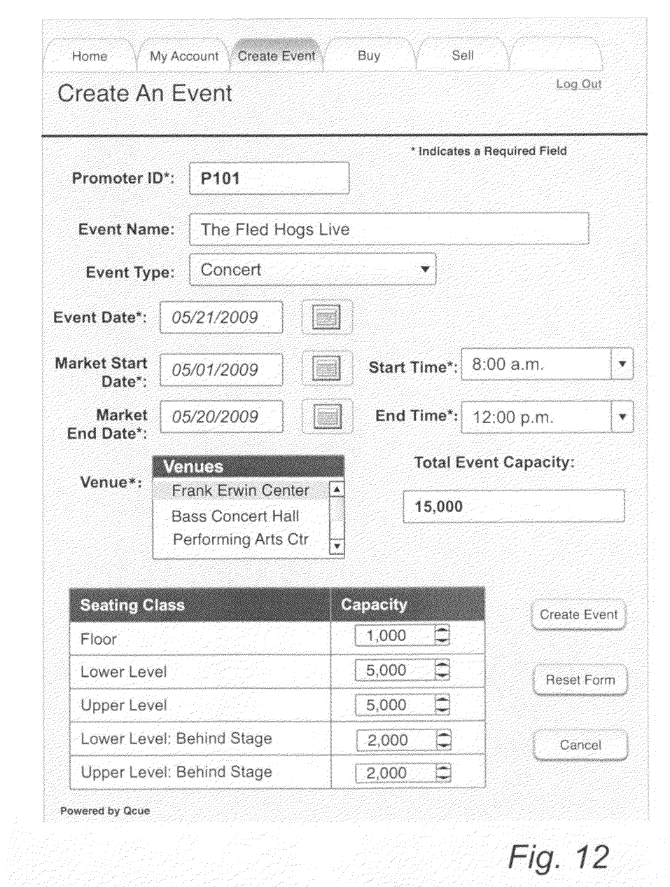

FIG. 12 is an exemplar of a user interface window displayed to a promoter 101 in a browser 103 of the promoter's computer 105. A promoter 101 is presented with a create event page in which the promoter 101 may designate an event name, event type, the date of the event, a venue for the event, event capacity, and define seating classes in which tickets to the event will be issued.

After the promoter 101 has filled in all relevant information to create the event, a message to create the event is transmitted to the exchange 409 from the promoter's computer 105, step 903. The exchange 409 creates the required entries in the database 411, step 905. Next the promoter 101 defines the securities to be associated with the event, step 907. After the promoter has defined the securities, a message to create the securities is transmitted to the exchange 409 from the promoter's computer 105, step 909 and the exchange 409 creates the required entries in the database, step 911.

Having created the event and associated securities, the promoter 101 may decide to release some of the promoter's ticket inventory as an initial sale. If an initial release of inventory is to be made, decision step 913, a message including the quantity and price of tickets to be released or a set of rules governing how the exchange 409 is to release and price forward contracts to be released is transmitted to the exchange 409, step 915, and upon receipt, the exchange 409 creates an entry in the Orders database table 817, step 917. In the alternative in which a set of rules governs pricing and release of forward contracts, the exchange 409 may use sales history of previously released forward contracts as input to these rules, i.e., a rule may state that if the first x tickets are sold within y days, release another n forward contracts at price p plus or minus a given delta. The promoter 101 defines the rules to apply based on parameters defined by the exchange 409.

There is no requirement that the promoter 101 releases an initial set of ticket inventory into the market managed by the exchange 409. Persons or entities with an interest in acquiring tickets, or the opportunity to resell tickets, or more precisely the forward contracts exchangeable for delivery of tickets from the promoter 101 may enter bids for such unreleased inventory. Depending on the prices that the bidders present, the promoter 101 may release forward contracts after some initial bidding has occurred. The promoter 101 can use these bids to set the prices and quantity of the initial release following rules of a first price or second price auction. Alternatively, the promoter 101 can use the information contained in these bids to cancel the event or change the venue or venue configuration to be associated with the event.

In one embodiment, the promoter 101 may use information from the integrated market to price subsequent releases. The exchange 409 may provide a suggested price based on the transaction history. One method for determining the suggested price is to use an automated algorithm for which asks originating from the issuer are not listed on the order book. Instead upon receipt of each query to the exchange 409 for a market price, a price for tickets held by the primary seller 101 is generated automatically based upon existing bids and asks, the quantity requested by the potential buyer, and historical market data to maximize the promoter's 101 expected revenue. Expected revenue to promoter 101 is the price offered by promoter 101 added to the expected non-ticket revenue associated with the additional end consumers, accounting for the fact that the quantity of tickets in this order that will come from the promoter 101 multiplied by probability that a customer purchases a futures contract is decreasing in the offered price. The price offered by the promoter 101 to the consumer is then a weighted average of the price of the promoter 101 and non-promoter tickets. Additionally, the price determination may include the promoter's 101 expected revenue for tickets not sold in this transaction, based upon future expected arrivals and bids in the order book. Given an ability to accept remaining bids upon market close, the promoter 101 has a salvage value for otherwise unsold tickets that may be used by a price optimization function to price more aggressively since the cost of unsold tickets is lower.

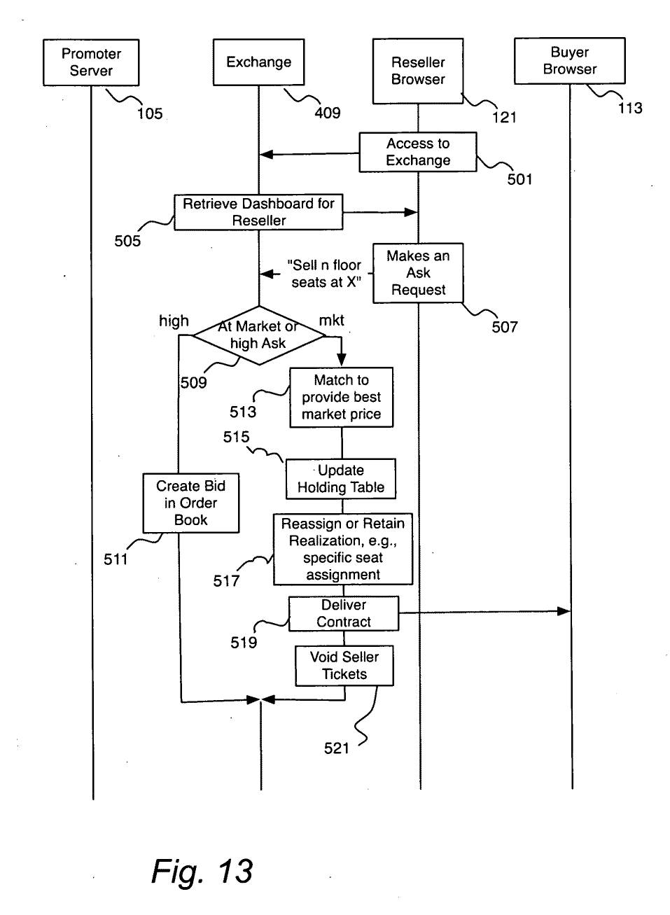

FIG. 13 is a timing sequence diagram illustrating the offering of securities on the exchange 409. FIG. 13 contemplates a scenario involving a promoter 101, the exchange 409, a reseller 117 (operating a browser 121 on a computer 119), and an end user customer 111 (operating a browser 113 on a computer 115). As noted above, the interaction, in one embodiment, may be web based. In an alternative embodiment, the interaction between the promoter 101 and the exchange 409 is through a box office system 201 that may or may not be network based. However, here, for illustrative purposes a network based solution is illustrated and, thus, the promoter 101 interacts with the exchange 409 using a browser 103. Similarly, an end user customer 111 wishing to purchase forward contracts sold on the exchange 409 interacts using a browser 113 executing on the customer's computer 115. The browsers 121 and 113 may be web browsers such as Safari from Apple Inc., Cupertino, Calif., or Internet Explorer from Microsoft Corporation, Redmond, Wash., or alternatively application browsers especially tailored to interact with the exchange 409.

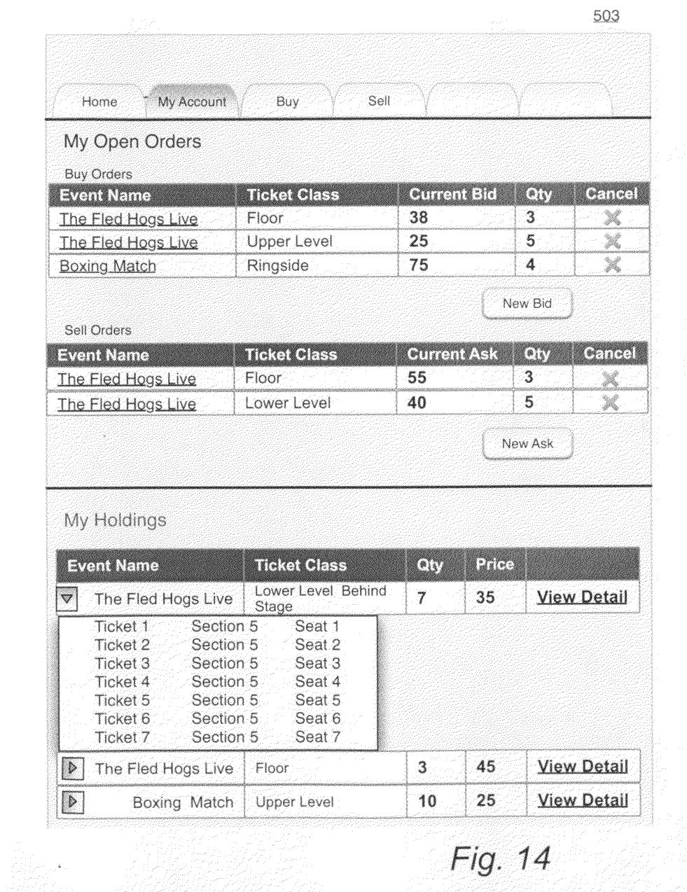

A reseller 117 wishing to sell a block of forward contracts in tickets that the reseller 117 holds accesses the exchange 409, step 501. The exchange 409 responds by sending to the reseller browser 121a web page containing a dashboard for the user that is the reseller 117, step 505. FIG. 14 is an exemplar web page dashboard 505 for a user. This particular user dashboard 505 indicates that the user that is the reseller 117 has an open order to purchase 3 contracts for floor seats for the Fled Hogs Live event at $38.00 (bidding is discussed herein below). More importantly for this immediate discussion, the reseller 117 holds 5 floor seats and 7 seats in the lower behind stage section. The reseller 117 may sell any of those holdings on the exchange 409 by placing an ask request, step 507. The ask request communicates a quantity, a security ID, and the price the reseller 117 is requesting. Alternatively the reseller 117 may indicate a desire to sell at market price.

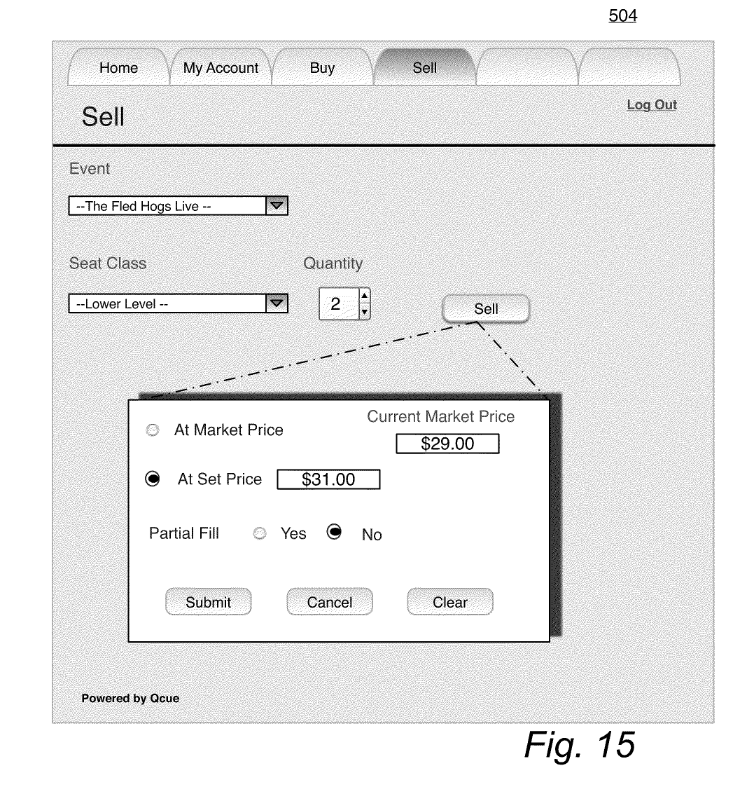

FIG. 15 is an exemplar user interface page 504 illustrating the user interface that is presented to a reseller 117 in the reseller's browser 121 to affect a sale of holdings the reseller 117 has.

If the reseller 117 indicates a particular ask price, i.e., one higher than the current market price, decision step 509, the ask order is placed in the order book, i.e., in the Orders database table 817, step 511. Conversely, asks lower than the market price clear immediately if a match may be established.

On the other hand, if a market order has been placed, the best market price will be obtained for reseller 117 by matching bid orders in the order book against the seller asks, step 513. Usually that involves taking the highest bid price and transferring those holdings in the Holdings database table 809 from the reseller 117 to the end user customer 111 who has made that corresponding high bid, step 515. However, obtaining the best market price may mean matching bids and asks in a manner to provide a maximized market price for the reseller 117.

Matching of sell orders to bids in the order book, i.e., step 513, is described in greater detail below.

Purchases of ticket forward contracts are discussed herein below. However, as discussed there, in one embodiment, seat assignments, i.e., the acquisition of a specific identity of an item in a class of items traded on the market, are withheld until delivery of the tickets at the close of the market. In an alternative, at the time a ticket forward contract is sold on the exchange 409, that realization is removed. As discussed above, the matching mechanism may cause a transfer of actual seat assignments from one holder of forward contracts to another holder, thus the original seat assignment may be removed and new seats assigned, step 517. In the alternative embodiment, delayed realization, wherein seat assignments are made at the time of delivery of tickets by the promoter 101, the step of reassigning seat assignments is unnecessary.

Next the forward contract is delivered to the end consumer customer 111 who placed the matched bid, step 519. Delivery may mean delivering actual tickets or a promise, made by the promoter 101, to deliver actual tickets at a future date and time.

As delivery of a contract may mean delivery of actual tickets, in that embodiment, the resold forward contracts are then voided, step 521. In one embodiment, tickets are issued at the time the forward contracts are sold, i.e., in step 519. In that embodiment, tickets may have an associated voidable feature, e.g., a bar code identifier. That voidable feature is indicated as voided in the voided field of the Holdings table 809. If a bearer of such a ticket were to present the voided ticket at a ticket booth to gain entry to the event, the validation of the ticket, e.g., by checking the voidable feature (e.g., bar code) against the database entries of valid tickets, would fail and the bearer would be turned away.

A promoter 101 may participate on the exchange 409 as a seller of forward contracts on tickets. The promoter 101 benefits from participating on the exchange 409, in that the market mechanisms for establishing ticket prices allow the promoter 101 to set an accurate price for the tickets in the promoter's inventory.

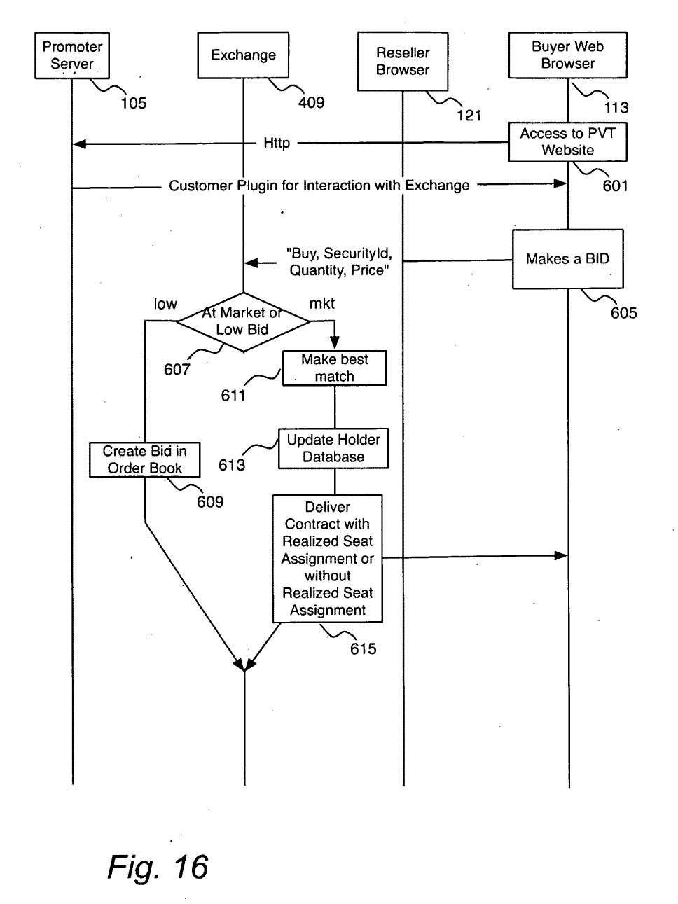

FIG. 16 is a timing sequence diagram illustrating the bidding for securities on the exchange 409. FIG. 16 contemplates a scenario involving a promoter 101, the exchange 409, a reseller 117 (operating a browser 121 on a computer 119), and an end user customer 111 (operating a browser 113 on a computer 115). As noted above, the interaction may, in one embodiment, be web based. In an alternative embodiment, the interaction between the promoter 101 and the exchange 409 is through a box office system that may or may not be network based. However, here, for illustrative purposes a network based solution is illustrated and, thus, the promoter interacts with the exchange 409 using a browser 103. Similarly, an end consumer customer 111 wishing to purchase forward contracts sold on the exchange 409 interacts using a web browser 113 executing on the buyer's computer 115.

A user wishing to interact with the exchange 409 accesses the promoter's website, step 601, which would be transmitted to the promoter's web server 105. To allow access to the exchange, a mechanism for interacting with the exchange 409 may need to be loaded from the server 105. Also, some account establishment and log in procedure may be required.

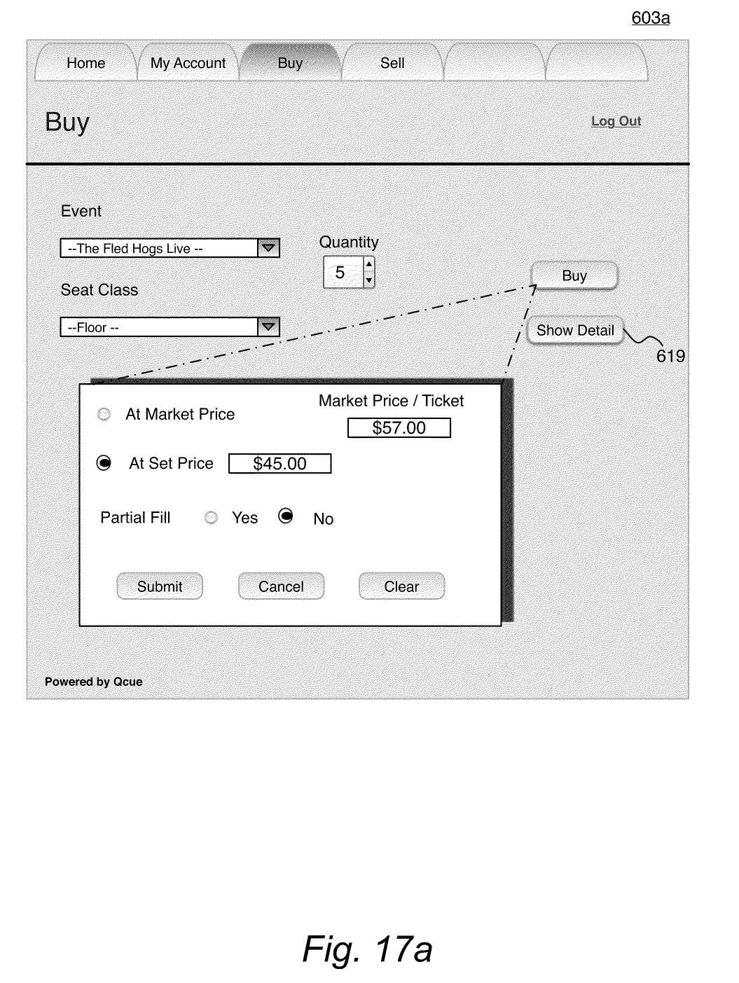

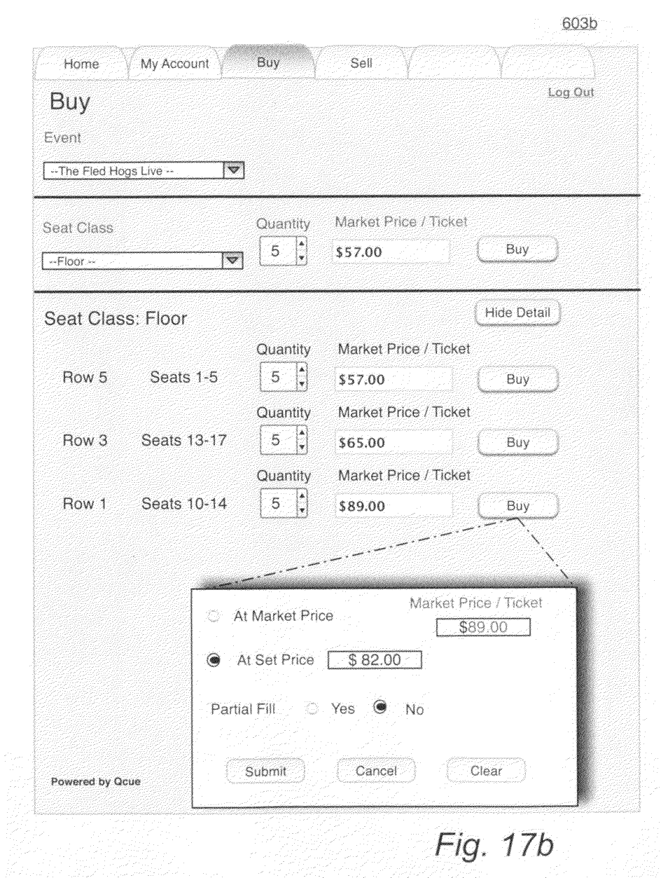

Having been logged in, the buyer is presented with a web page showing available events and securities, e.g., web page 603 illustrated in FIG. 17 (which is presented in two figures, FIG. 17a which illustrates bidding on a class of tickets, and FIG. 17b which illustrates bidding on classes that are subsets of the more general class of tickets). Using the web page 603a or 603b, the customer 111 selects an event to purchase tickets for, or more accurately, to purchase forward contracts guaranteeing delivery of corresponding tickets to the event, step 605. For example, as illustrated in web page 603a, the customer has selected to bid $45.00 per ticket for 5 contracts (corresponding to five seats) for floor seats. This information is transmitted from the customer's web browser 113 to the exchange 401, step 607. As note above, the customer may actually make these bids directly with the box office 201 and it is the box office 201 that performs the requisite interaction with the exchange 409. Alternatively, the customer may bid on subsets of the group of floor seats, in this case, individual seats as illustrated in FIG. 17b. In the web page 603a (FIG. 17a) the user may elect to expand the class, by pressing an show details button 619. The expansion of the ticket class is illustrated in web page 603b (FIG. 17b). In the example, of FIG. 17b the customer has selected to make a bid of $82 per ticket for an offering of tickets at Row 1, Seats 10-16. When a customer makes a bid that is lower than the ask price for specific seats, that offer is communicated by the exchange 409 to the holder of that contract for acceptance or rejection. However, if the customer enters the market price, i.e., when for specific seats, the offer price, the transfer takes place and the database 411 is updated. In the case of the bid of $45.00 for five floor seats in FIG. 17b, this bid could be accepted by any holder of 5 floor seats. Similarly the market price for 5 floor seats is $57.00, the lowest price of any set of individual floor seats.

The bid may either be a market bid, in which the exchange endeavors to provide the buyer the best possible price by matching bids and asks in the order queue, or the bid may be at a specified price lower than the market price. If the bid is at a specified price, decision box 607, the bid is entered into the order book, i.e., into the Orders table 817, step 609. On the other hand, if the bid is for the market price, the best possible price is offered to the buyer by combining existing bids and asks as discussed herein above, step 611. The transfer of rights in contracts is reflected in the Holding table 809, step 613.

Finally, the forward contract in the tickets reflecting the transfer of rights based on the match is delivered to the buyer, step 615. As discussed hereinabove, the seller's realization may either be transferred directly to the new buyer or, if multiple sellers' inventories were used to fulfill the order, a reassignment of realization in form of seat assignments may take place. Furthermore, in an embodiment where delivery of the rights associated with a forward contract is accompanied by a delivery of tickets, the seller's tickets are voided.

The integrated market in forward contracts on the exchange 409 allows the promoter 101 to actively participate in that market and benefit from the market's price setting function. When a promoter logs into the exchange, the promoter 101 may observe the activity of the market in the promoter's dashboard 701 illustrated in FIG. 17.

There are several aspects to matching bids and asks. First, in one embodiment of the invention, the matching mechanisms of the exchange 409409 endeavors to provide a buyer or seller who places an order to buy or sell at market price with the best possible quoted price based on the existing orders in the order book. Second, in the embodiment in which seats are allocated at the time that forward contracts are issued, i.e., there is heterogeneity realized in the holdings of the forward contracts, that heterogeneity is dealt with by the matching mechanism of the exchange 409 to allocate seats such that the buyers obtain what they are seeking to buy by reallocation of seat assignments in the holdings of sellers with open orders or of the primary seller. The matching operates comparably if a market order is presented to the exchange 409 on the sell side versus on the buy side.

Consider first the situation of a market in which heterogeneity is dealt with by making seat allocations after the market closes, i.e., there are no seat assignments at the time of matching. Consider the following example order book:

TABLE 1
Sample Order Book

| BID | | | ASK | | |
|---|---|---|---|---|---|
| B1 | 5 (partial fill not | 120 | A1 | 7 (partial fill not | 100 |
| | allowed) | | | allowed) | |
| B2 | 5 (partial fill not | 100 | A2 | 2 | 200 |
| | allowed) | | | | |

In this sample order book of Table 1, a first buyer, B1, wishes to buy 5, but not less than 5, tickets at $120 each for a total of $600, and a second buyer, B2, wishes to buy 5, but not less than 5, tickets at $100, for a total of $500. On the ask side one seller, A1, is offering 7, but not less than 7. tickets, at $100 per ticket, for a total of $700, and a second seller, A2, is offering 2 tickets at $200 per ticket, for a total of $400.

Consider a third buyer, B3, that submits a buy at market buy request for 2 tickets. Neither B1 nor B2 can satisfy this request because of the partial-fill-not-allowed requirement that their purchases and the A1's sale not be broken up. In this scenario the best possible scenario without combining existing orders in the order book with the placed market order would be A2's $200 per ticket for a total of $400.

However, the exchange 409 endeavors to give the market buyer the best possible price. By combining the offers of B1 and B3 to satisfy the ask of A1, B3 may be given a much lower price. The $600 offered by B1 combined with $100 from B3 adds up to the requested $700 of A1. Thus, B3 is allowed to buy 2 tickets at $50 per ticket. Had the orders of B2 and B3 been combined, the price per ticket offered to B3 would have been $100 per ticket.

By combining orders, the exchange 409 provides at least two significant benefits. First, it allows the buyer B to obtain tickets at a very good price without penalizing the other participants in any way; they each obtain the benefit that they desired from the orders that they had placed, respectively. Second, the order book possessed illiquidity despite being crossed, the bid price from B1 is in excess of the ask price of A1. However, a sale could not have been completed due to the partial-fill-not-allowed restriction. Furthermore, B3 would have been offered a price of $200 per ticket, which would likely be rejected based upon the value that other market participants placed upon these forward contracts. However, by combining the orders of B3 and B1 to satisfy A1's order, all three of these participants achieved the result they sought due to the increased market liquidity resulting from the ability to combine orders. As a result B3 was able to presented an acceptable offer and the market is likely uncrossed.

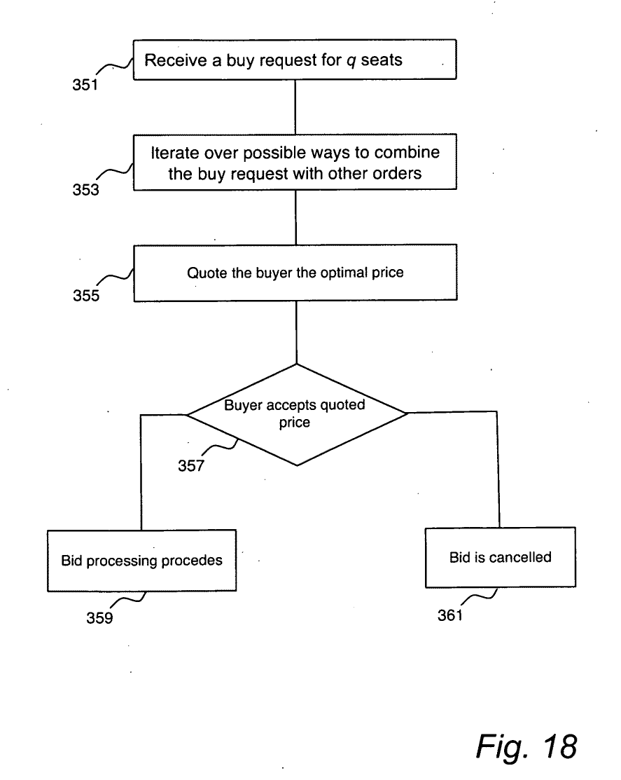

FIG. 18 is a flow chart illustrating the operations that the matching mechanism of the exchange 409 uses to provide the best possible price for a buyer.

Consider that a buyer, B, requests a quote for q seats, step 351. To obtain the best possible price for the at-market buyer in the embodiment where the realization of heterogeneity is deferred to ticket delivery, the matching mechanism of the exchange 409 iterates over the possible combinations of transactions given the current order book as follows, step 353:

bestPrice ← A(q)/q ; q quantity in request
{A(q) - is the lowest dollar amount associated
with asks having quantities totaling q}
{B(q) - is the highest dollar amount associated
with bids having quantities totaling q}
n − upper bound of ask quantities we will try,
e.g., sum of all ask quantities − q
for i = 1 to n

for j = 0 to i

price = (A(q+i) − B(j))/q

if price <= best price then

bestPrice ← price;

The exchange 409 quotes the buyer the bestPrice, step 355, by transmitting a user interface screen back to the browser of the computer of the buyer who placed the bid B. The buyer B may either accept or decline the quoted price, decision step 357. If the buyer accepts, the bid processing proceeds as illustrated in FIG. 16, step 359. Otherwise, the bid is cancelled, step 361.

In another embodiment, the price quoted may be increased above the calculated best price to clear additional orders. That price increase may be determined based on knowledge of how the probability that the buyer accepts is decreasing with an increase in offered price.

In an alternative embodiment, heterogeneity of the underlying items is taken into account by the matching mechanism. Consider the following Holdings database:

| | | | |
|---|---|---|---|
| Issuer | 50 Floor Tickets | Row 10 | Seats 1-50 |
| H2 | 3 Floor Tickets | Row 1 | Seats 7, 8, and 9 |
| H3 | 1 Floor Ticket | Row 7 | Seat 4 |

Now consider a buy request from buyer B for 4 Floor tickets together. If the best match for price is obtained by combining the holdings of H2 and H3, it is desirable to fill the buy request using those holdings. However, because the realization into seat assignments would be non-contiguous, the buy order could not be directly filled from H2 and H3. Therefore, the exchange 409 transfers some of Issuer's floor tickets to the buyer and is in exchange therefore awarded the holdings of H2 and H3. Thus, after this transaction has been processed, the Holdings database may have the following values:

| | | | |
|---|---|---|---|
| Issuer | 50 Floor Tickets | Row 10 | Seats 1-46 |
| | | Row 1 | Seats 7, 8, and 9 |
| | | Row 7 | Seat 4 |
| H2 | 0 | | |
| H3 | 0 | | |
| B | 4 Floor Tickets | Row 10 | Seats 47-50 |

Thus, transferring inventory is desirable in that it promotes market liquidity. It allowed the buyer to obtain the order that the buyer was looking for, and satisfied the sell requests of two resellers. In one embodiment, the seats transferred to the issuer are chosen to be contiguous with existing inventory when such an option exists.

While FIG. 18 and the accompanying description describes how the exchange 409 operates to combine orders in response to receiving an order to buy forward contracts at market price to provide that buyer with an optimal price, the exchange 409 performs a corresponding matching process when presented with a sell at market price order.

From the foregoing it will be apparent that the method of operating a computer system and a computer system for providing an exchange in forward contracts exchangeable for delivery of tickets as described herein provides a solution for the primary seller that allows the primary seller to use dynamic pricing for events in conjunction with resellers activity in a market established using the exchange. That solution provides arrival at the correct price, adjustment of price in the face of changing market conditions; and control of the secondary market to capture-value from inevitable resale. This allows a primary seller to simultaneously address his two largest concerns: mitigating the risk of poor attendance and profiting from resale.

Furthermore the system and method described herein merges the primary and secondary markets for event tickets into one integrated market, as well as for other markets in heterogeneous goods, through an exchange in which items lose their separate identities thereby becoming exchange tradable.

From the description above, the advantages of the present system and method become evident. The system and method providing market mechanisms for trading in forward contracts on heterogeneous goods described herein consisting of fully integrating the primary and secondary markets for these items by commoditizing the item allows for:
Maintaining the homogeneity of items, or converting heterogeneous items into homogenous forward contracts, thereby making buyers and sellers anonymous, increasing the liquidity of the market, and easing resale.
A single market price at any point in time.
Resale to be integrated into the purchase process at the point of sale.
The primary seller gaining the power to dynamically price to market in response to readily observable demand and competing supply.
The alleviation of lines, lotteries, and other non-efficient methods of distribution for high-demand, limited supply items.
Removal of complementarities, thereby increasing the size of the market.

Accordingly, the reader will see that this system and method providing market mechanisms for trading in forward contracts on heterogeneous goods described herein has the capability of integrating what has hereto been disjointed primary and secondary markets, increasing the overall value of the market and creating an environment more profitable for primary sellers and more efficient for all parties involved.

Although specific embodiments of the invention have been described and illustrated, the invention is not to be limited to the specific forms or arrangements of parts so described and illustrated. The invention is limited only by the claims.

1. A box office for trading in forward contracts exchangeable for tickets to events, comprising:
a computerized exchange for trading forward contracts exchangeable for tickets to events, the exchange comprising:
a storage medium having instructions and data structures;
a central processing unit operable to manipulate the data structures and to perform operations based on the instructions, the instructions including: instructions to cause the central processing unit to create a market for forward contracts exchangeable for tickets issued from an issuer wherein each forward contract guarantees delivery of at least one ticket satisfying a ticket description, the instructions including instructions to cause the central processing unit to:
receive bid and ask requests for forward contracts exchangeable for tickets wherein each bid and ask includes a tickets description;
match bid records against ask records using a matching criteria including instructions to match multiple asks to satisfy one bid by aggregating tickets descriptions from the multiple asks or unreleased ticket inventory to satisfy the tickets description in a bid record; and
upon close of the market in forward contracts exchangeable for tickets, delivering from the issuer to a holder of forward contracts, tickets corresponding to each respective forward contract ticket description.

2. The box office for trading in forward contracts exchangeable for tickets to events of claim 1 wherein the ask requests being from sellers seeking to sell forward contracts exchangeable for tickets to events ticket contracts and bid requests being from buyers seeking to buy forward contracts exchangeable for tickets to events.

3. The box office for trading in forward contracts exchangeable for tickets to events of claim 1 further comprising instructions to cause the central processing unit to:
assign seats to tickets corresponding to each forward contract upon delivery of tickets at the close of the market in forward contracts exchangeable for tickets to events.

4. The box office for trading in forward contracts exchangeable for tickets to events of claim 1 further comprising instructions to cause the central processing unit to:
upon sale of a forward contract exchangeable for delivery to an event, reassigning seats as necessary to satisfy a bid order from non-contiguous ask orders.

5. The box office for trading in forward contracts exchangeable for tickets to events of claim 4 wherein the reassignment of seats includes removing seats in the issuer's inventory to fill an order and replacing the seats removed from the issuer's inventory with seats associated with an ask order matched to a bid order.

6. The box office for trading in forward contracts exchangeable for tickets to events of claim 1 further comprising instructions:
issuing tickets with the issuance of forward contracts exchangeable for tickets; and
upon sale of a forward contract exchangeable for tickets by a reseller, voiding the tickets corresponding to the forward contract held by the reseller and issuing new tickets to the buyer of the forward contract sold by the reseller.

7. The box office for trading in forward contracts exchangeable for tickets to events of claim 6 further comprising instructions to record the voiding of a ticket corresponding to a resold forward contract in a database.

8. The box office for trading in forward contracts exchangeable for tickets to events of claim 1 further comprising instructions:
to present user with an opportunity to select between purchasing forward contracts exchangeable for tickets in a class of tickets corresponding to assigned seats and purchasing forward contracts exchangeable for particular seats assigned to a forward contract.

9. The box office for trading in forward contracts exchangeable for tickets to events of claim 1 further comprising instructions:
to present a seller with an opportunity to select between receiving bids on his forward contracts exchangeable for tickets as part of a class of tickets corresponding to assigned seats and receiving bids on his forward contracts exchangeable for tickets as part of a class of tickets corresponding to assigned seats and as the particular seats assigned to the forward contract.

10. The box office for trading in forward contracts exchangeable for tickets to events of claim 1 wherein the instructions further comprise instructions to cause the central processing unit to:
collect historical trade information on forward contracts during operation of a market of forward contracts exchangeable for tickets for an event;
use the historical trade information, current order book, and quantity associated with query for market price to determine suggested ask price; and
represent the suggested ask on the order book as belonging to the issuer.

11. The box office for trading in forward contracts exchangeable for tickets to events of claim 1 wherein the instructions further comprise instructions to cause the central processing unit to:
set quantity and price of initial release of forward contracts exchangeable for tickets to an event by auction.

12. The box office for trading in forward contracts exchangeable for tickets to events of claim 1 wherein the aggregation of ticket descriptions from multiple asks or unreleased ticket inventory comprises aggregating i) one or more tickets for which the seller bought rights in one or more secondary transactions, or ii) one or more tickets for which the seller bought rights in one or more secondary transactions and one or more tickets issued from unreleased ticket inventory.

13. A method of operating a box office for trading in forward contracts exchangeable for tickets to events to create a computerized market for forward contracts exchangeable for tickets issued from an issuer wherein each forward contract guarantees delivery of at least one ticket satisfying a ticket description, comprising:
receive on a server computer bid and ask requests for forward contracts exchangeable for tickets wherein each bid and ask includes a tickets description and is transmitted to the server computer from a user;
operating the server computer to match bid records against ask records using a matching criteria including instructions to match multiple asks to satisfy one bid by aggregating tickets descriptions from the multiple asks or unreleased ticket inventory to satisfy the tickets description in a bid record; and
upon close of the market in forward contracts, causing the server computer to deliver from the issuer to a holder of forward contracts, tickets corresponding to each respective forward contract ticket description.

14. The method of operating a box office for trading in forward contracts exchangeable for tickets to events of claim 13 wherein the ask requests being from sellers seeking to sell forward contracts exchangeable for tickets to events and bid requests being from buyers seeking to buy forward contracts exchangeable for tickets to events.

15. The method of operating a box office for trading in forward contracts exchangeable for tickets to events of claim 13 further comprising operating the server computer to assign seats to tickets corresponding to each forward contract upon delivery of tickets at the close of the market in forward contracts exchangeable for tickets to events.

16. The method of operating a box office for trading in forward contracts exchangeable for tickets to events of claim 13 upon sale of a forward contract exchangeable for delivery to an event, causing the server computer to reassign seats as necessary to satisfy a bid order from non-contiguous ask orders.

17. The method of operating a box office for trading in forward contracts exchangeable for tickets to events of claim 16 wherein the reassignment of seats includes removing seats in the issuers inventory to fill an order and replacing the seats removed from the issuer's inventory with seats associated with an ask order matched to a bid order.

18. The method of operating a box office for trading in forward contracts exchangeable for tickets to events of claim 13 further comprising operating the server computer to:
issue tickets with the issuance of forward contracts exchangeable for tickets; and
upon sale of a forward contract by a reseller, voiding the tickets corresponding to the forward contract held by the reseller and issuing new tickets to the buyer of the forward contract sold by the reseller.

19. The method of operating a box office for trading in forward contracts exchangeable for tickets to events of claim 13 further comprising operating the server computer to record voiding of a ticket corresponding to a resold forward contract in a database.

20. The method of operating a box office for trading in forward contracts exchangeable for tickets to events of claim 13 further comprising presenting a user with an opportunity to select between purchasing forward contracts exchangeable for tickets in a class of tickets corresponding to assigned seats and purchasing forward contracts exchangeable for particular seats assigned to a forward contract:

21. The method of operating a box office for trading in forward contracts exchangeable for tickets to events of claim 13 further comprising presenting a seller with an opportunity to select between receiving bids on his forward contracts exchangeable for tickets as part of a class of tickets corresponding to assigned seats and receiving bids on his forward contracts exchangeable for tickets as part of a class of tickets corresponding to assigned seats and as the particular seats assigned to the forward contract.

22. The method of operating a box office for trading in forward contracts exchangeable for tickets to events of claim 13 wherein the aggregation of ticket descriptions from multiple asks or unreleased ticket inventory comprises aggregating i) one or more tickets for which the seller bought rights in one or more secondary transactions, or ii) one or more tickets for which the seller bought rights in one or more secondary transactions and one or more tickets issued from unreleased ticket inventory.

23. The method of operating a box office for trading in forward contracts exchangeable for tickets to events of claim 13 further comprises:
collecting historical trade information on forward contracts during operation of a market of forward contracts exchangeable for tickets for an event;
using the historical trade information, current order book, and quantity associated with query for market price to determine suggested ask price; and
representing the suggested ask on the order book as belonging to the issuer.

24. The box office for trading in forward contracts exchangeable for tickets to events of claim 13 further comprises:
setting quantity and price of initial release of forward contracts exchangeable for tickets to an event by auction.

25. A box office for trading in forward contracts exchangeable for tickets to events, comprising:
a computerized exchange for trading forward contracts exchangeable for tickets, the exchange comprising:
a storage medium having instructions and data structures;
a central processing unit operable to manipulate the data structures and to perform operations based on the instructions;
a network connection connected to the central processing unit and to a network, the network connection operable to enable the data processing system to receive messages from and transmit messages to remote client computers;
wherein the instructions comprise instructions to cause the central processing unit to:
associate an entity, as a holder, with a forward contract exchangeable for tickets to an event, wherein the forward contract guarantees delivery of at least one ticket satisfying a contract definition from a ticket issuer to the holder wherein the contract definition provides a definition translatable into seat assignments;
receive on the network bid messages for forward contracts exchangeable for tickets to the event from prospective buyers of forward contracts for tickets to the event; and
receive on the network ask messages from respective holders of forward contracts for tickets to the event;
wherein the data structures further comprises:
an order book data structure associating bid values and ask values with respect to forward contracts exchangeable for tickets, and a holder data structure associating the respective forward contracts with the respective holders of each forward contract in the market for forward contracts exchangeable for tickets to the event;
wherein the instructions further comprise instructions to cause the central processing unit to:
create a bid record in the order book data structure in response to receiving a bid message;
create an ask record in the order book data structure in response to receiving an ask message from a holder of a forward contract;
match bid records against ask records against a matching criteria including instructions to match multiple asks or unreleased ticket inventory to satisfy one bid by coalescing contract definitions from the multiple asks or unreleased ticket inventory to satisfy the contract definition in a bid record;
upon successfully matching a bid to an ask for one of the forward contracts, update a record in the holder data structure to identify the buyer associated with the matching bid for the forward contract as the current holder of the forward contract corresponding to the ask record;
upon a closing of the market, deliver tickets satisfying the contract definition corresponding to each respective forward contract to the holder of the forward contract as indicated in the holder data structure at the time of closing of the market in forward contracts for tickets to the event.

26. The box office for trading in forward contracts exchangeable for tickets to events of claim 25 wherein the contract definition specifies a quantity and a section of a venue in which the event is to take place.

27. The box office for trading in forward contracts exchangeable for tickets to events of claim 26 wherein the contract definition further specifies at least one of a requirement for contiguous seats, seats contiguous with another user, and a subset of a section.

28. The box office for trading in forward contracts exchangeable for tickets to events of claim 25 wherein each bid and ask specifies a contract definition and a price and quantity wherein the match criteria is satisfied if the contract definition of a set bids is compatible with the contract definition for a set of asks and if the total price for the set of bids is greater than or equal to the total price for the set of asks.

29. The box office for trading in forward contracts for tickets to events of claim 25 wherein a contract definition of a bid is compatible with a contract definition of an ask if the bid contract definition is the same as the ask contract definition or a superset of the ask contract definition.

30. The box office for trading in forward contracts for tickets to events of claim 25 wherein the instructions to match bid records against ask records include instructions to aggregate multiple bids to satisfy one ask, to aggregate multiple asks to satisfy one bid, and to aggregate multiple asks to satisfy multiple bids.
